(19) United States
(12) Patent Application Publication
(10) Pub. No.: US 2017/0004258 A1
(43) Pub. Date: Jan. 5, 2017

(54) MEDICAL INTERVENTION DATA DISPLAY FOR PATIENT MONITORING SYSTEMS

(71) Applicant: KONINKLIJKE PHILIPS N.V., Eindhoven (NL)

(72) Inventors: Dong WANG, SCARSDALE, NY (US); Limei CHENG, IRVINE, CA (US)

(21) Appl. No.: 15/104,817

(22) PCT Filed: Dec. 16, 2014
(86) PCT No.: PCT/IB2014/066968

§ 371 Date: Jun. 15, 2016

Related U.S. Application Data
(60) Provisional application No. 61/919,021, filed on Dec. 20, 2013.

(51) Int. Cl. G06F 19/00

(52) U.S. Cl. CPC G06F 19/322; G06F 19/3406

(57) ABSTRACT

A system (10) and a method (100) integrate the display of vital signs data and relevant medical intervention data. Measurements of a vital sign of a patient are received (102) and a graph (30) of the measurements over time illustrating a trend of the vital sign is displayed (106). Data describing a medical intervention affecting the vital sign is received (104) and an indicator (40) of the medical intervention on the graph (30) at a time of the medical intervention is displayed (108). Predictions of the effect of the medical intervention on the vital sign are further received (110) and displayed temporally synchronized with the measurements (112).

The present application relates generally to patient monitoring. It finds particular application in conjunction with displaying medical interventions, and will be described with particular reference thereto. However, it is to be understood that it also finds application in other usage scenarios and is not necessarily limited to the aforementioned application.

With the advance of health information technologies (HIT) and electronic medical record (EMR) technologies, more and more patient data is available to support clinicians in diagnosing and treating patients. With a network connection, clinicians can access patient data, such as medical records, medication information, medical history, and vital sign data, anytime and anywhere. However, patient data is not currently presented in an integrated way. Different types of patient data may be stored on different devices and/or displayed on different user interfaces even though closely related.

For example, vital sign data and medical intervention data, such as medication data, are not displayed together to help clinicians quickly and accurately assess patient status. Rather, vital sign data and medical intervention data are usually stored and displayed separately and independently. Vital sign data is usually displayed as continuous waveforms or numbers on a patient monitor device or remote patient monitoring workstation, whereas medical intervention data is usually displayed as text documents (e.g. doctor orders or notes, or EMRs).

With only vital sign data, clinicians may not be able to accurately evaluate patient status since medical interventions can cause vital sign changes. For example, the blood pressure drop in a patient with hypertension may come from a medication of vasodilation given to the patient, rather than patient recovery. In many cases, clinicians have to switch back and forth between vital sign displays and EMR displays to identify if observed vital sign changes are caused by medical interventions, such as drugs, and to evaluate the current status of a patient and whether the medical interventions take effect. While switching back and forth, clinicians need to search for any relevant medical interventions and then match and synchronize those relevant medical interventions with the vital sign data in the time domain to determine if vital sign changes are as expected. This process is very time consuming and significantly reduces clinicians' workflow efficiency.

The present application provides a new and improved system and method which overcome these problems and others.

In accordance with an aspect of the present application, a system for integrating the display of vital sign data and relevant medical intervention data is provided. The system includes at least one processor configured for receiving measurements of a vital sign of a patient and displaying a graph of the measurements over time illustrating a trend of the vital sign. The at least one processor is further configured for receiving data describing a medical intervention affecting the vital sign and displaying an indicator of the medical intervention on the graph at a time of the medical intervention.

In accordance with another aspect of the present application, a method for integrating the display of vital sign data and relevant medical intervention data is provided. The method includes receiving measurements of a vital sign of a patient and displaying a graph of the measurements over time illustrating a trend of the vital sign. The method further includes receiving data describing a medical intervention affecting the vital sign and displaying an indicator of the medical intervention on the graph at a time of the medical intervention.

In accordance with another aspect of the present application, a system for integrating the display of vital sign data and relevant medical intervention data is provided. The system includes a display device, a first module, and a second module. The first module controls the display device to display a graph of measurements of a vital sign of a patient over time. The graph illustrates a trend of the vital sign. The second module controls the display device to display an indicator of a medical intervention affecting the vital sign on the graph at a time of the medical intervention.

One advantage resides in improved workflow efficiency.

Another advantage resides in improved assessment of patient status.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

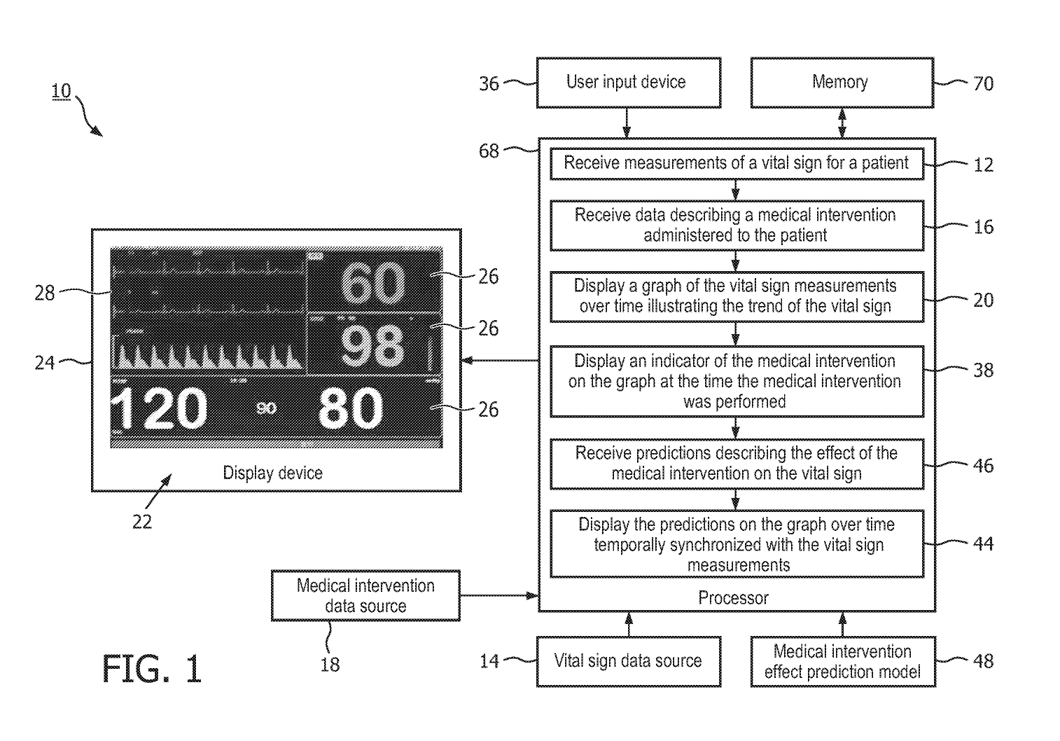

FIG. 1 illustrates a patient monitoring system integrating the display of vital sign data and relevant medical intervention data.

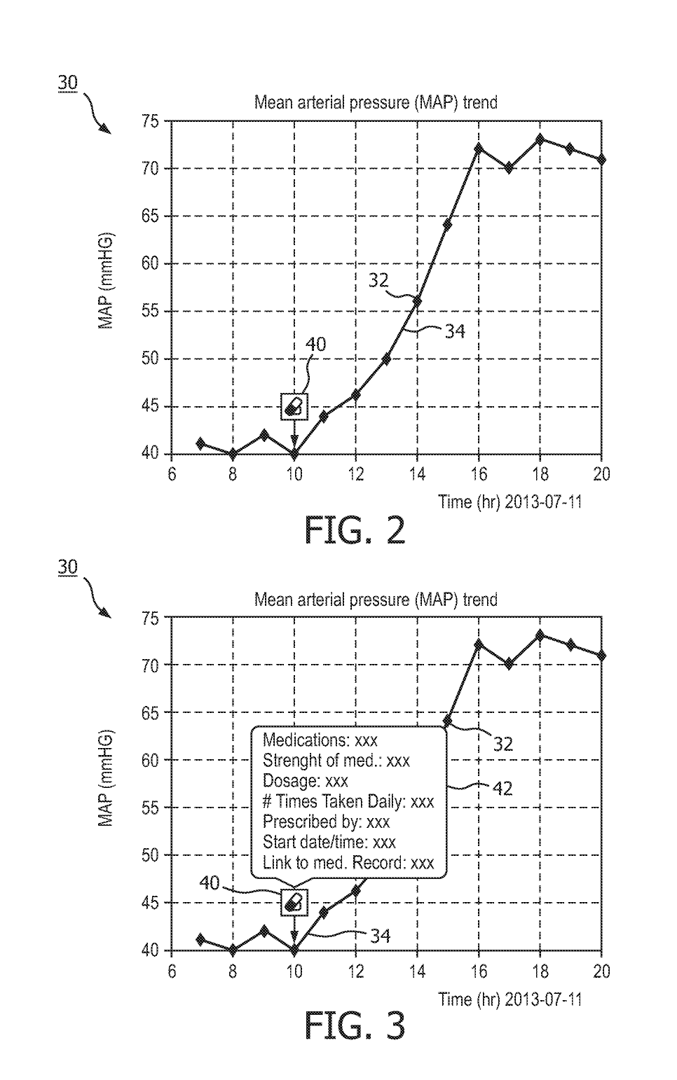

FIG. 2 illustrates a graph of measurements of a vital sign and an indicator for a medical intervention affecting the vital sign.

FIG. 3 illustrates a graph of measurements of a vital sign and details regarding a medical intervention affecting the vital sign.

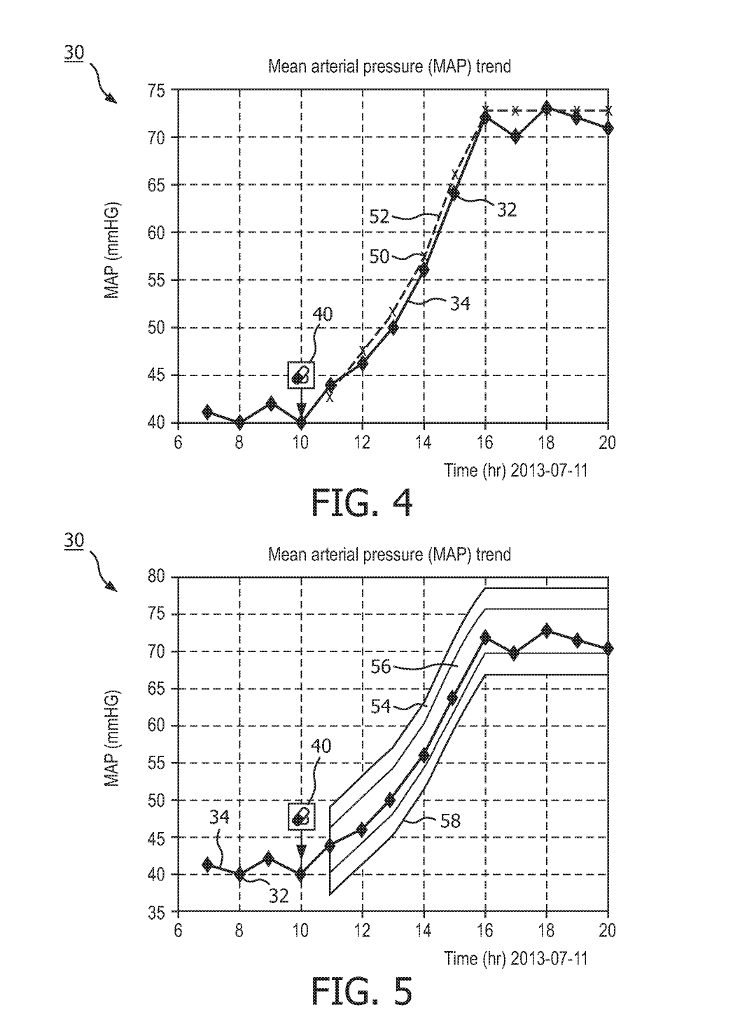

FIG. 4 illustrates a graph of measurements of a vital sign and single value predictions of the vital sign due to a medical intervention.

FIG. 5 illustrates a graph of measurements of a vital sign and regions of patient severity based on predictions of the vital sign due to a medical intervention.

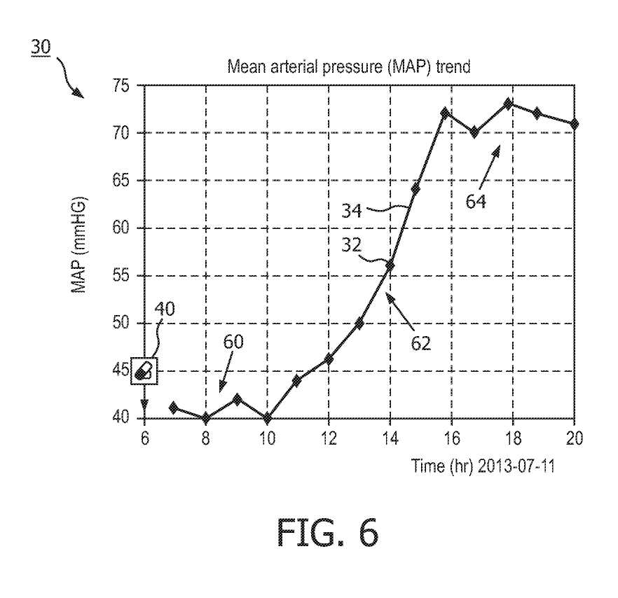

FIG. 6 illustrates a graph of measurements of a vital sign and a trend line connecting the measurements color coded based on predictions of the vital sign due to a medical intervention.

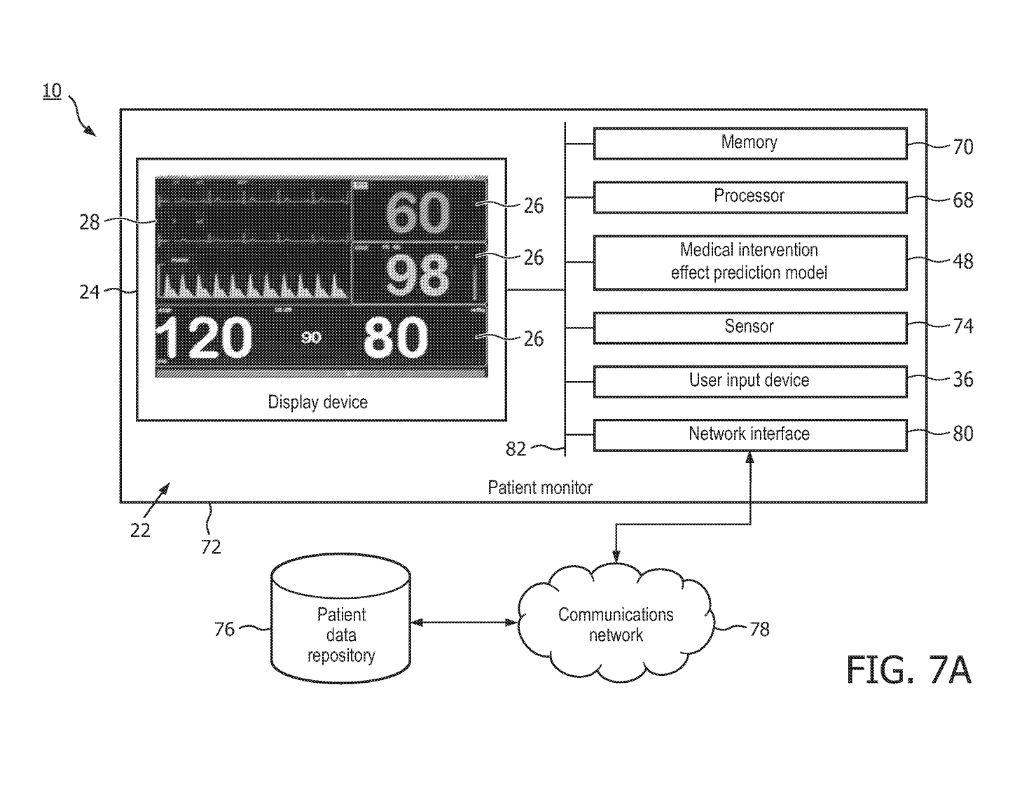

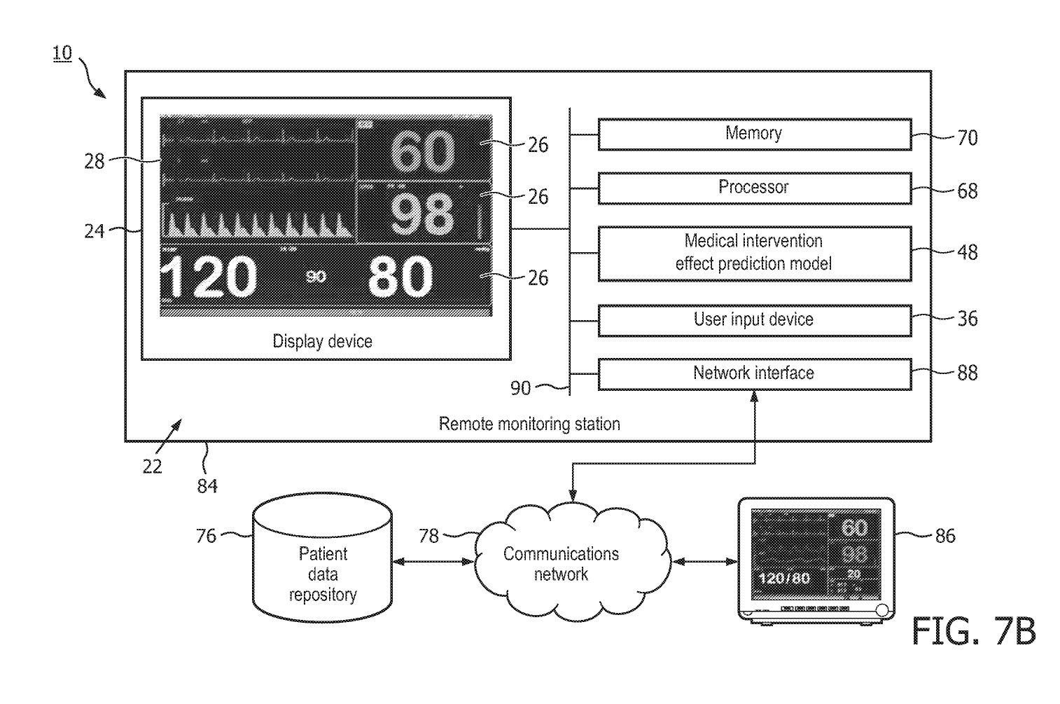

FIG. 7A illustrates a patient monitor integrating the display of vital sign data and relevant medical intervention data.

FIG. 7B illustrates a remote patient monitoring station integrating the display of vital sign data and relevant medical intervention data.

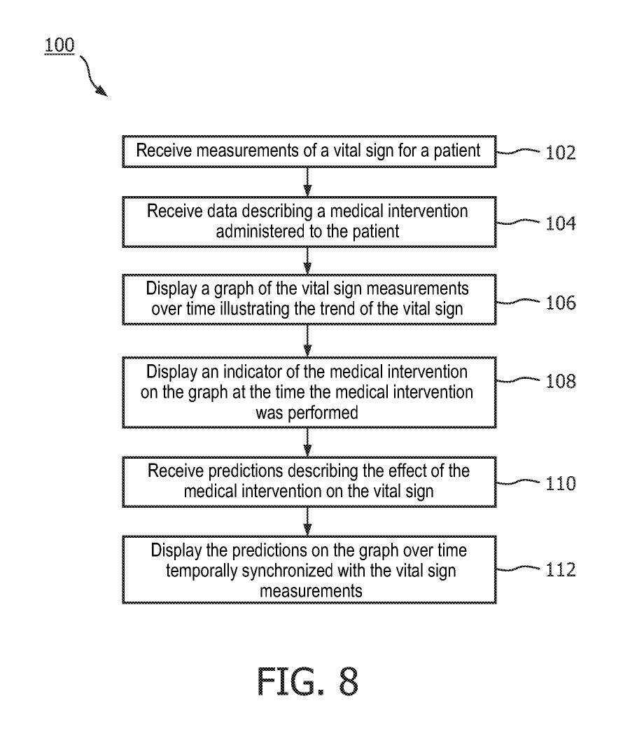

FIG. 8 illustrates a method of integrating the display of vital sign data and relevant medical intervention data.

The present application describes a patient monitoring system displaying data regarding administered or recommended medical interventions, such as the administering of medications, together with measurements for a relevant patient vital sign. The patient vital sign data is displayed on a graph illustrating the trend of the vital sign over time, and the medical intervention data is displayed on the graph synchronized along the time axis. By displaying administered medication interventions with the measurements, clinicians can better assess patient status and determine whether a medical intervention takes effect.

Expected vital sign changes due to a medical intervention are predicted quantitatively by a prediction model either automatically or manually by clinicians. The predictions are plotted together with the measurements on the graph and, in the case of an administered medical intervention, provide a more complete view of patient status. Alternatively, in the case of an administered medical intervention, the predications can be employed as a reference for corresponding measurements. Representative markers and/or a trend line of the measurements can be color coded based on the predictions (e.g. black or green for normal, yellow for moderate deterioration, and red for severe deterioration) to help clinicians quickly capture any patient condition changes. Further, numerical ranges or limits corresponding to different patient conditions (e.g., normal, moderate deterioration, and severe deterioration) and based on the predictions can be graphically displayed.

With reference to FIG. 1, a patient monitoring system 10 integrating the display of vital sign data and relevant medical intervention data is illustrated. Data regarding an administered or recommended medical intervention (i.e., medical intervention data) is relevant to measurements of a vital sign (i.e., vital sign data) if the medical intervention can affect the vital sign. For example, a medication of vasodilation given to a patient can affect the blood pressure of the patient.

The vital sign data is received 12 over time from one or more vital sign data sources 14, typically in real-time. A vital sign data source 14 is a source of measurements for a vital sign of a patient. Examples of vital signs include systolic blood pressure (SBP), heart rate (HR), oxygen saturation (SpO2), mean arterial pressure (MAP), and so on. Examples of vital sign data sources 14 include a patient data repository, a patient monitor, a vital sign sensor (e.g., a SpO2 sensor or an ECG sensor), a user input device (e.g., for clinician input), and so on. Typically, the vital sign data sources 14 are vital sign sensors or patient monitors.

Similar to the vital sign data, the medical intervention data is received 16 over time from one or more medical intervention data sources 18. A medical intervention data source 18 is a source of data regarding a medical intervention administered to, or recommended for administration to, a patient. Examples of medical interventions include the administering of medication and fluids, as well as the enabling or disabling of a ventilator. Examples of medical intervention data sources 18 include a patient data repository, a patient monitor, a user input device (e.g., for clinician input), a clinical decision support system, and so on. Typically, the medical intervention data sources 18 for administered medical interventions are patient data repositories, and the medical intervention data sources 18 for recommended medical interventions are clinical decision support systems, which typically base the recommendations on patient vital signs and medical records.

The received vital sign data is displayed 20 on a display 22 of the patient monitoring system 10 using a display device 24. The display 22 includes one or more vital sign windows 26 for the vital sign data. A vital sign window 26 is a region of the display 22, typically a subset of the display 22, allocated to the display of a vital sign for a patient. As illustrated, the display 22 includes multiple vital sign windows 26, one for HR (i.e., 60), SpO2 (i.e., 98%), and noninvasive blood pressure (i.e., 120/80 millimeter of mercury (mmHg) with an atmospheric pressure of 90 mmHg). The display 22 can further include one or more additional windows 28 for other types of patient data, such as the illustrated electrocardiograms (ECGs) and plethysmogram.

With further reference to FIGS. 2-6, the measurements for a vital sign are typically displayed in the corresponding vital sign window 26 according to one of two display modes. According to the first display mode, the measurements of the vital sign are displayed as a function of time on a graph 30 illustrating the trend of the vital sign over time. The independent axis of the graph 30 represents the value of the vital sign and the dependent axis represents time. Markers 32 are used to represent the location of the measurements on the graph 30. In some instances, the graph 30 includes a trend line 34 connecting the graphed measurements. According to the second display mode, only the most recent measurement of the vital sign is displayed, as illustrated in FIG. 1.

In some instances, a user of the patient monitoring system 10 can toggle between the two display modes using a user input device 36. The toggling can be initiated by selecting a toggle button. Alternatively, the toggling can be initiated by selecting the appropriate one of a first mode button (i.e., a button entering the first mode) and a second mode button (i.e., a button entering the second mode). Alternatively, the toggling can be initiated by selecting regions of the display 22 inside and outside of the vital sign window 26. For example, supposing the vital sign window 26 initially displays only the most recent measurement, selecting a region within the vital sign window 26 replaces the most recent measurement with a graph 30 illustrating the trend of the vital sign over time. Thereafter, selecting a region outside the vital sign window 26 returns the vital sign window 26 to only displaying the most recent measurement for the vital sign.

A graph 30 for a vital sign according to the first display mode is further displayed 38 with received medical intervention data relevant to the vital sign integrated therewith. As noted above, data regarding a medical intervention (i.e., medical intervention data) is relevant to measurements of a vital sign (i.e., vital sign data) if the medical intervention can affect the vital sign. Further, as noted above, a medical intervention can be an administered medical intervention or a recommended medical intervention.

With reference to FIG. 2, the medical intervention data is displayed by displaying each of the one or more medical interventions of the medical intervention data as an icon 40 on the graph 30 at the time along the time axis of the graph 30 that corresponds to the medical intervention. The corresponding time of an administered medical intervention is the time the medical intervention was administered, and the corresponding time of a recommended medical intervention is the recommended time for administering the medical intervention. For example, as illustrated, the trend of MAP of a patient is shown over a 14 hour period and an icon 40 at hour 10 represents the administration of medication to the patient at hour 10. In some instances, different icons 40 can be used to represent different types of medical interventions, such as medication, ventilation weaning, and so on. For example, the administration of medication can employ an icon 40 of pills, and the administration of fluids can employ an icon 40 of an intravenous (IV) bag.

With reference to FIG. 3, in some instances, users can select (e.g., click on) an icon 40 representing a medical intervention using a user input device 36 (see FIG. 1) to obtain more details about the medical intervention. The additional data can be displayed within a tooltip 42 anchored to the icon location, as illustrated, or within a new window opened in response to the user selection. Additional data that can be displayed includes one or more of an identification of a medication (e.g., medication name), a strength of the medication, a dosage of the medication, the number of times the medication is to be administered daily, the prescribing clinician, the start date and/or time for the medication, and a link to the electronic medical record (EMR) of the patient.

Referring back to FIG. 1, a graph 30 (see FIGS. 2-6) for a vital sign can be further displayed 44 with medical intervention effect prediction data for the one or more administered medical interventions affecting the vital sign. Medical intervention effect prediction data is data regarding the effect an administered medical intervention has on a vital sign. The displayed medical intervention effect prediction data includes predictions spanning the one or more temporal ranges of displayed vital sign measurements effected by administered medical interventions, such as a prediction at the time of each displayed vital sign measurement effected by an administered medical intervention. The prediction for a time point can include a single, predicted value, or ranges of predicted values corresponding to different patient conditions, such as a normal range, a moderate warning range, and a severe warning range. The display of medical intervention effect prediction data can be triggered automatically or manually by a clinician using a user input device 36.

The medical intervention effect prediction data is received 46 from a medical intervention effect prediction model 48, such as a pharmacokinetic/pharmacodynamic (PK/PD) model. The specific approach by which the medical intervention effect prediction model 48 predicts the effect of administered medical interventions on the vital sign is beyond the scope of the present application. However, any well-known model for predicting the effect of an administered medical intervention on a vital sign can be employed. Further, the medical intervention effect prediction model 48 can be employed to predict the combined effect of multiple medical interventions on the vital sign.

With reference to FIG. 4, when the predictions of received medical intervention effect prediction data are single, predicted values, the predictions can be plotted as a function of time on the graph 30 to illustrate the trend of the predictions. To that end, markers 50 are used to represent the locations of the predictions on the graph 30. The markers 50 of the predictions are typically different than the markers 32 of the measurements. For example, “X”s and diamonds, can be used to mark predictions and measurements, respectively, on the graph 30. In some instances, the graph includes a trend line 52 connecting the graphed predictions. As with the markers 50 of the predictions, the trend line 52 of the predictions is typically different than the trend line 34 of the measurements. For example, the predicted trend line 52 can be displayed in green (a color commonly associated with “normal”), whereas the measured trend line 34 can be displayed in black. Through visual comparison of the predicted and measured markers 32, 50, and/or the predicted and measured trend lines 34, 52, a clinician can easily determine whether the patient status is normal.

With reference to FIG. 5, ranges corresponding to different patient conditions, such as severe, moderate and normal, can be displayed as a function of time on the graph 30. The ranges can correspond to predicted ranges of received medical intervention effect prediction data, or ranges predefined by clinicians using a user input device 36 which are centered on single, predicted values of received medical intervention effect prediction data. For example, a clinician can define a normal range as +/−5% of a predicted value, and a moderately abnormal range as 5% to 15% of a predicted value or −15% to −5%.

The ranges are displayed by uniquely identifying the regions 54, 56, 58 of the graph 30 (e.g., with background color) covered by the ranges. For example, a green region 56 can be employed for a normal range, a yellow region 54, 58 can be employed for a moderate, abnormal range, and a red region can be employed for a severe, abnormal range. In this way, a clinician can easily see which range a vital sign measurement falls within to assess patient status. As illustrated, measurements of a vital sign stay within a normal range over time, but come close to a moderate, abnormal range around hour 17.

With reference to FIG. 6, the trend line 34 and/or the markers 32 of the measurements can be coded (e.g., using color, pattern, shape, and so on) based on the predictions. Specifically, segments 60, 62, 64 of the trend line 34 and/or the markers 32 of the measurements are displayed based on corresponding ranges of patient severity. For example, if a measurement falls within a normal range, the marker 32 for the normal range is used to represent the measurement. As another example, if a segment 60, 62, 64 of the trend line 34 falls within a severe, abnormal range, the segment 60, 62, 64 is displayed in a manner defined for the severe, abnormal range (e.g., using a red line color). The ranges can correspond to predicted ranges of received medical intervention effect prediction data, or ranges predefined by clinicians using a user input device which are centered on single, predicted values of received medical intervention effect prediction data. As illustrated, the MAP of the patient is severely abnormal from hours 7 to 13. Thereafter, the MAP of the patient is moderately abnormal from hours 13-16 and the MAP of the patient is normal from hours 16 to 20.

The foregoing actions 12, 16, 20, 38, 46, 44 of receiving and displaying data are each a software module, a hardware module, or a hybrid software and hardware module. A software module for an action is software, which is executed by one or more processors 68 of the patient monitoring system 10 and which is stored on one or more memories 70 of the patient monitoring system 10 associated with the processors 68. The processors 68 perform the action by executing the software on the memories 70. A hardware module for an action is a device performing the action. A hybrid software and hardware module includes software and hardware modules. Typically, the actions 12, 16, 20, 38, 46, 44 of receiving and displaying data are performed by one or processors 68 executing software stored on the one or more associated memories 70, as illustrated.

In addition to the foregoing actions 12, 16, 20, 38, 46, 44 of receiving and displaying data, the medical intervention effect prediction model 48 is embodied by a software module, a hardware module, or a hybrid software and hardware module. Software, hardware and hybrid modules are as described above. In some instances, the medical intervention effect prediction model 48 is implemented by a software module executed by the same processors 68 performing the actions 12, 16, 20, 38, 46, 44 of receiving and displaying data. In this instance, the medical intervention effect prediction model 48 can be software stored on the same memories 70 storing the software modules embodying the actions 12, 16, 20, 38, 46, 44 of receiving and displaying data.

With reference to FIG. 7A, the patient monitoring system 10 includes a patient monitor 72, such as a bedside/portable patient monitor device, performing the foregoing actions 12, 16, 20, 38, 46, 44 of receiving and displaying data in an integrated manner by way of one or more processors 68 executing software embodying the actions 12, 16, 20, 38, 46, 44 stored on one or more memories 70. The patient monitor 72 receives at least some of the vital sign data locally from one or more sensors 74 of the patient monitor 72. The sensors 74 include, for example, and SpO2 sensor. Further, the patient monitor 72 typically receives the medical intervention data from a remote, patient data repository 76 over a communications network 78 using a network interface 80. The remote patient data repository 76 typically includes EMRs and other patient medical data. The components 24, 36, 48, 68, 70, 74, 80 of the patient monitor 10 are suitably interconnected locally by one or more data buses 82.

With reference to FIG. 7B, the patient monitoring system 10 includes a remote patient monitoring station 84 performing the foregoing actions 12, 16, 20, 38, 46, 44 of receiving and displaying data in an integrated manner by way of one or more processors 68 executing software embodying the actions 12, 16, 20, 38, 46, 44 stored on one or more memories 70. The remote patient monitoring station 84 receives at least some of the vital sign data remotely from one or more patient monitors 86. Further, the remote patient monitoring station 84 typically receives the medical intervention data from a remote, patient data repository 76. The remote data is received over a communications network 78 using a network interface 88. The components 24, 36, 48, 68, 70, 88 of the remote patient monitoring station 84 are suitably interconnected locally by one or more data buses 90.

With reference to FIG. 8, a method 100 integrating the display of vital sign data and relevant medical intervention data is illustrated. Data regarding an administered or a recommended medical intervention is relevant to measurements of a vital sign if the medical intervention can affect the vital sign. The method 10 is typically performed by the patient monitor 72 of FIG. 7A or the remote patient monitoring station 84 of FIG. 7B, but has broader applicability as shown in FIG. 1.

The method 100 includes receiving 102 measurements of a vital sign for a patient over time, typically in real time. For example, a new measurement can be received every second. The vital sign data is typically received from a vital sign sensor or a patient monitor. Data describing an administered or recommended medical intervention given to the patient and relevant to the vital sign is further received 104. A medical intervention is relevant to a vital sign if the medical intervention affects the vital sign by, for example, increasing or decreasing the vital sign. Medical intervention data is typically received from a patient data repository.

Using the received data, a graph of the vital sign measurements over time is displayed 106 on a display device with an optional trend line connecting the vital sign measurements. The measurements are, for example, displayed on the graph with markers. Further, an indication of the medical intervention is displayed 108 on the graph at the time of the medical intervention. If the medical intervention is an administered medical intervention, the time of the medical intervention is the time the medical intervention was performed. If the medical intervention is a recommended medical intervention, the time of the medical intervention is the recommended time for performing the medical intervention. The medical intervention is displayed with, for example, an icon. The icon can be selected with a user input device to display additional details regarding the medical intervention. Further, the icon can vary depending upon the type of medical intervention.

In some instances, when the medical intervention is an administered medical intervention, predictions describing the effect of the medical intervention on the vital sign are received 110. A prediction is typically received for each time point of the vital sign measurements. Further, a prediction can be a single value or a range of values corresponding to different severities, such as normal, moderately abnormal and severely abnormal. The predictions are typically received from a medical intervention effect prediction model. The received predictions are displayed 112 on the graph over time temporally synchronized with the vital sign measurements.

The predictions can be plotted on the graph over time with a trend line connecting the predictions where the predictions are single values. Alternatively, the predictions can be displayed on the graph as code zones, such as color coded zones, corresponding to ranges of patient severity. Where the predictions are single values, the ranges are defined by clinicians based on the predictions. For example, a normal range is +/−5% of the prediction. Where the predictions are ranges, these ranges are employed. Alternatively, the predictions can be displayed on the graph by coding, such as color coding, markers of the predictions and/or segments of the trend line of the vital sign measurements based on corresponding ranges of patient severity. For example, segments corresponding to different ranges of patient severity can be assigned different colors.

The foregoing actions 102, 104, 106, 108, 110, 112 of the method 100 are each a software module, a hardware module, or a hybrid software and hardware module. A software module for an action is software, which is executed by one or more processors of the patient monitoring system and which is stored on one or more memories of the patient monitoring system associated with the processors. The processors perform the action by executing the software on the memories. A hardware module for an action is a device performing the action. A hybrid software and hardware module includes software and hardware modules.

As used herein, a memory includes any device or system storing data, such as a random access memory (RAM) or a read-only memory (ROM). Further, as used herein, a processor includes any device or system processing input device to produce output data, such as a microprocessor, a microcontroller, a graphic processing unit (GPU), an application-specific integrated circuit (ASIC), an FPGA, and the like; a controller includes any device or system controlling another device or system; a user input device includes any device, such as a mouse or keyboard, allowing a user of the user input device to provide input to another device or system; and a display device includes any device for displaying data, such as a liquid crystal display (LCD) or a light emitting diode (LED) display.

The invention has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof.

1. A system for integrating the display of vital sign data and relevant medical intervention data, the system comprising:
at least one processor configured for:
receiving measurements of a vital sign of a patient;
displaying a graph of the measurements over time illustrating a trend of the vital sign;
receiving data describing a medical intervention affecting the vital sign; and
displaying an indicator of the medical intervention on the graph at a time of the medical intervention.

2. The system according to claim 1, further including:
a medical intervention effect prediction model;
wherein the at least one processor is further configured for:
receiving predictions of the effect of the medical intervention on the vital sign at varying times from the medical intervention effect prediction model; and
displaying the predictions on the graph over time and temporally synchronized with the measurements.

3. The system according to claim 2, wherein the at least one processor is further configured for:
concurrently displaying markers representing the measurements and markers representing the predictions on the graph, the markers for the measurements different than the markers for the predictions.

4. The system according to claim 2, wherein the at least one processor further configured for at least one of:
displaying ranges of patient severity based on the predictions in the background of the graph and over time;
displaying markers representing the measurements on the graph and coded based on ranges of patient severity, the ranges of patient severity based on the predictions; and
displaying a trend line connecting the markers and coded based on the ranges of patient severity.

5. (canceled)

6. (canceled)

7. The system according to claim 1, wherein the medical intervention was administered to the patient, and the time of the medical intervention is the time the medical intervention was administered to the patient.

8. The system according to claim 1, wherein the medical intervention is a recommendation for administration to the patient, and the time of the medical intervention is the time the medical intervention is recommended for administration.

9. The system according to claim 1, wherein the indicator is an icon specific to a type of the medical intervention.

10. The system according to claim 1, wherein the at least one processor is further configured for:
displaying additional details regarding the medical intervention in response to user selection of the indicator.

11. The system according to claim 1, further including one of:
a patient monitor including the at least one processor; and
a remote patient monitoring station including the at least one processor.

12. A method for integrating the display of vital signs data and relevant medical intervention data, the method comprising:
receiving measurements of a vital sign of a patient;
displaying a graph of the measurements over time illustrating a trend of the vital sign;
receiving data describing a medical intervention affecting the vital sign; and
displaying an indicator of the medical intervention on the graph at a time of the medical intervention.

13. The method according to claim 12, further including:
receiving predictions of the effect of the medical intervention on the vital sign at varying times; and
displaying the predictions on the graph over time and temporally synchronized with the measurements.

14. The method according to claim 13, further including:
concurrently displaying markers representing the measurements and markers representing the predictions on the graph the markers for the measurements different than the markers for the predictions.

15. The method according to claim 13, further including:
displaying ranges of patient severity based on the predictions in the background of the graph and over time; and
displaying markers representing the measurements on the graph and coded based on ranges of patient severity, the ranges of patient severity based on the predictions.

16. (canceled)

17. (canceled)

18. At least one processor programmed to perform the method according to claim 12.

19. (canceled)

20. A system for integrating the display of vital sign data and relevant medical intervention data, the system comprising:
a display device;
a first module which controls the display device to display a graph of measurements of a vital sign of a patient over time, the graph illustrating a trend of the vital sign; and
a second module which controls the display device to display an indicator of a medical intervention affecting the vital sign on the graph at a time of the medical intervention.
